(19) United States
(12) Patent Application Publication
(10) Pub. No.: US 2026/0217186 A1
(43) Pub. Date: Jul. 30, 2026

(54) SYSTEMS AND METHODS FOR DYNAMIC SIGNAL SYSTEMS

(71) Applicant: Torc Robotics, Inc., Blacksburg, VA (US)

(72) Inventors: Maximilian Koeper, Baden-Wurttemberg (DE); Stefan Koch, Baden-Wurttemberg (DE); David Unger, Baden-Württemberg (DE)

(21) Appl. No.: 19/039,451

(22) Filed: Jan. 28, 2025

(51) Int. Cl. B60Q 1/50; B60Q 5/00

(52) U.S. Cl. CPC B60Q 1/543; B60Q 1/507; B60Q 5/005; B60Q 2800/10

(57) ABSTRACT

A system of an autonomous vehicle is described, the autonomous vehicle including a signal system located on an exterior of the autonomous vehicle, one or more processors, and a memory storing instructions that are executed by the one or more processors. The system is configured to determine, by the one more processors, a maneuver of the autonomous vehicle, wherein a portion of the autonomous vehicle will be outside of a lane of operation during the maneuver, generate, based on the maneuver, signal data corresponding to the maneuver, and transmit, to the signal system, the signal data, wherein the signal system emits an output signal based on the signal data.

### TECHNICAL FIELD

The field of the disclosure relates generally to autonomous vehicle systems and methods and, more specifically, to signal systems for autonomous vehicles for alerting nearby drivers and vehicles of movements of the autonomous vehicle.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system of an autonomous vehicle is described. The system includes one or more processors, a signal system located on an exterior of the autonomous vehicle and communicatively coupled to the one or more processors, and a memory storing instructions. The instructions, when executed by the one or more processors, cause the system to determine, by the one more processor, a maneuver of the autonomous vehicle, wherein a portion of the autonomous vehicle will be outside of a lane of operation during the maneuver. The instructions further configure the system to generate, based on the maneuver, signal data corresponding to the maneuver and transmit, to the signal system, the signal data, wherein the signal system emits an output signal based on the signal data.

In another aspect, a computer-implemented method is described. The method includes determining, by one more processors of an autonomous vehicle, a maneuver of the autonomous vehicle, wherein a portion of the autonomous vehicle will be outside of a lane of operation during the maneuver, generating, by the one or more processor of the autonomous vehicle and based on the maneuver, signal data corresponding to the maneuver, and transmitting, to a signal system of the autonomous vehicle, the signal data, wherein the signal system emits an output signal based on the signal data.

In yet another aspect, a non-transitory computer-readable storage medium is described. The non-transitory computer-readable storage medium includes instructions that when executed by a computer, cause the computer to determine a maneuver of an autonomous vehicle, wherein a portion of the autonomous vehicle will be outside of a lane of operation during the maneuver, generate, based on the maneuver, signal data corresponding to the maneuver, and transmit, to a signal system of the autonomous vehicle, the signal data, wherein the signal system emits an output signal based on the signal data.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a perspective view of an autonomous vehicle;

FIG. 2 is a block diagram of the autonomous vehicle shown in FIG. 1;

FIG. 3 depicts an example maneuver of an autonomous vehicle;

FIG. 4 is a flow diagram of an example method of signaling on an autonomous vehicle;

FIG. 5A-5C depict various embodiments of a signal system for an autonomous vehicle; and

FIG. 6 is a block diagram of an example computing system.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Autonomous vehicles generally include a computing system, such as an autonomy computing system, that employs continuous sensing and feedback to keep the autonomous vehicle operating in a desired fashion, e.g., within a desired lane. The autonomous vehicle plans maneuvers based on received sensor data. In some instances, maneuvers may require additional space, outside of the lane within which the autonomous vehicle is operating. Because the autonomous vehicle has precise information on the current location of the vehicle and any planned maneuvers, the autonomous vehicle knows in advance of any planned maneuvers that the maneuver will require additional space outside the lane of operation. In other words, the autonomous vehicle will have advanced warning if the autonomous vehicle will, at any time, enter a space other than the lane of operation.

In one example, the autonomous vehicle may be connected to a trailer. For vehicles pulling trailers, making a right-hand turn commonly involves the vehicle briefly entering a lane of oncoming traffic. This is done to allow for a wide right-hand turn to provide proper clearance for the trailer to safely navigate the turn to account for the swing radius of the trailer. While this is a well-known and common maneuver, it may be beneficial to provide indication to other drivers of the planned behavior of the vehicle. This could be in the form of audible and/or visual signals that can be heard or seen by other vehicles or drivers in the vicinity of the vehicle.

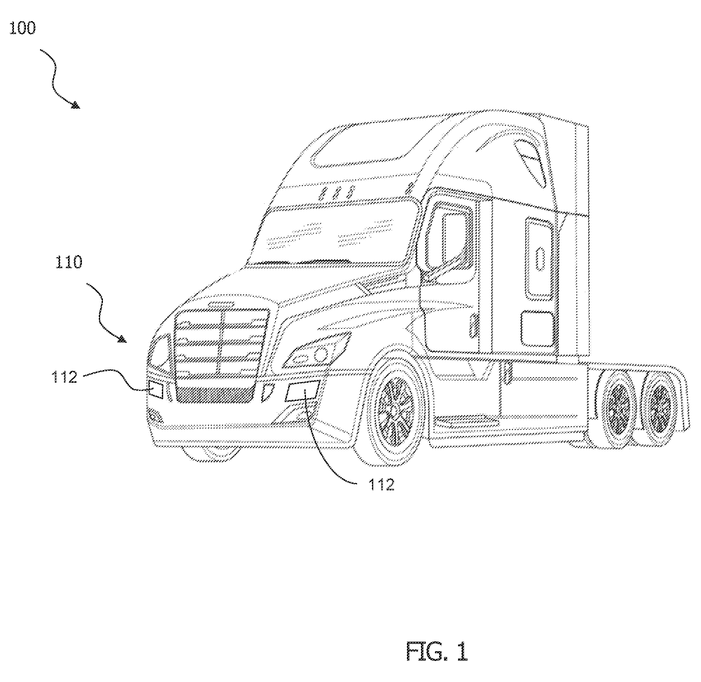

FIG. 1 illustrates a vehicle 100, such as a truck that may be conventionally connected to a single or tandem trailer to transport the trailer (not shown) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin (not shown in FIG. 1).

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

The vehicle 100 also includes a signal system 110. In one example, the signal system 110 is depicted mounted on a front portion of the vehicle 100, but the signal system 110 may be located on any surface of the vehicle 100. The signal system 110 may include one or more signal lights 112. The signal system may also include an audible indicator (not shown). The signal system 110 may receive instructions from an autonomy computing system of the vehicle to communicate movements and maneuvers of the vehicle to other vehicles, drivers, or anyone else in the vicinity of the vehicle 100, which will be described in greater detail below.

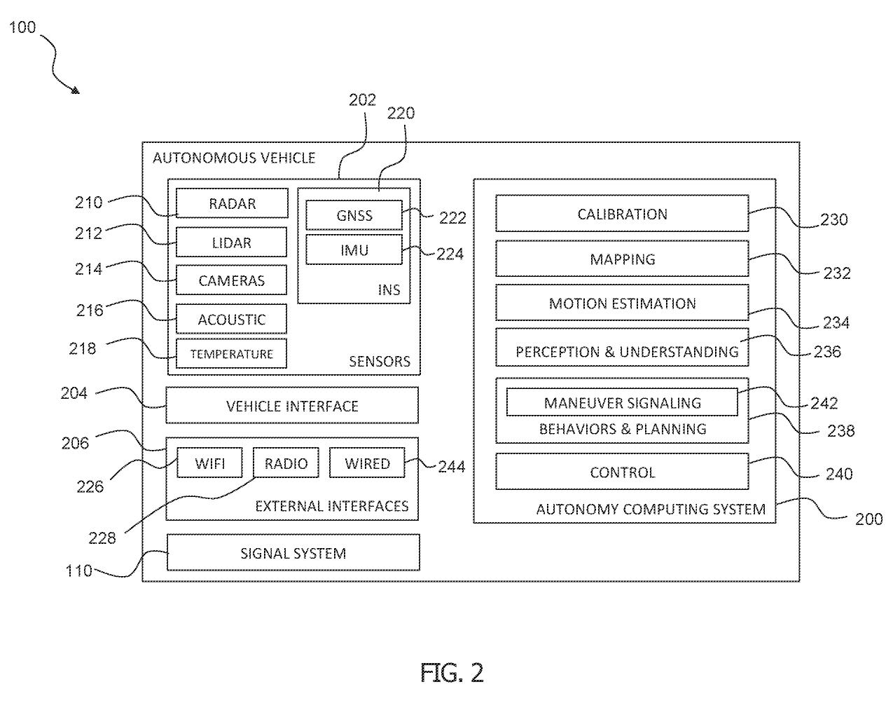

FIG. 2 is a block diagram of the vehicle 100 shown in FIG. 1. In the example embodiment, vehicle 100 includes autonomy computing system 200, sensors 202, a vehicle interface 204, and external interfaces 206. Vehicle 100 also includes a signal system 110. Signal system 110 may be similar to signal system 110 described above. Signal system 110 is shown may include one or more processors, memory, and communication interfaces that allow signal system 110 to receive signal data from the autonomy computing system 200. Signal system 110 includes one or more lights or audible indicators mounted on the exterior of the vehicle 100.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of vehicle 100 and its proximity. As described in further detail below, these signals may be used by autonomy computing system 200 to determine how to control operations of vehicle 100.

Cameras 214 are configured to capture images of the environment surrounding vehicle 100 in any aspect or field of view (FOV). The FOV can have any angle or aspect such that images of the areas ahead of, to the side, behind, above, or below vehicle 100 may be captured. In some embodiments, the FOV may be limited to particular areas around vehicle 100 (e.g., forward of vehicle 100, to the sides of vehicle 100, etc.) or may surround 360 degrees of vehicle 100. In some embodiments, vehicle 100 includes multiple cameras 214, and the images from each of the multiple cameras 214 may be processed to identify one or more construction markers or other objects in the environment surrounding vehicle 100. In some embodiments, the image data generated by cameras 214 may be sent to autonomy computing system 200 or other aspects of vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around vehicle 100.

GNSS receiver 222 is positioned on vehicle 100 and may be configured to determine a location of vehicle 100, which it may embody as GNSS data. GNSS receiver 222 may be configured to receive one or more signals from a global navigation satellite system (e.g., Global Positioning System (GPS) constellation) to localize vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of vehicle 100. For example, with two GNSS receivers 222, two attitude angles (e.g., roll and yaw) may be measured or determined. In some embodiments, vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about vehicle 100 and its environment.

IMU 224 is a micro-electrical-mechanical (MEMS) device that measures and reports one or more features regarding the motion of vehicle 100, although other implementations are contemplated, such as mechanical, fiber-optic gyro (FOG), or FOG-on-chip (SiFOG) devices. IMU 224 may measure an acceleration, angular rate, or an orientation of vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of vehicle 100.

In the example embodiment, autonomy computing system 200 employs vehicle interface 204 to send commands to the various aspects of vehicle 100 that actually control the motion of vehicle 100 (e.g., engine, throttle, steering wheel, brakes, etc.) and to receive input data from one or more sensors 202 (e.g., internal sensors). External interfaces 206 are configured to enable vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of vehicle 100 or when downloading mission data after completion of a trip. The connection(s) may be used to download and install various lines of code in the form of digital files (e.g., HD maps), executable programs (e.g., navigation programs), and other computer-readable code that may be used by vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. A maneuver signaling module 242, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard vehicle 100.

The maneuver signaling module 242 may perform one or more tasks including, but not limited to generating signal data corresponding to maneuvers of the vehicle 100. The signal data includes instructions for emitting a visual or audio output signal to surrounding vehicles and drivers of planned maneuvers of the vehicle 100. In particular, the maneuver signaling module 242 detects planned maneuvers of the vehicle 100 that may be considered abnormal or that may interfere with the surrounding vehicles or drivers and generates corresponding signal data.

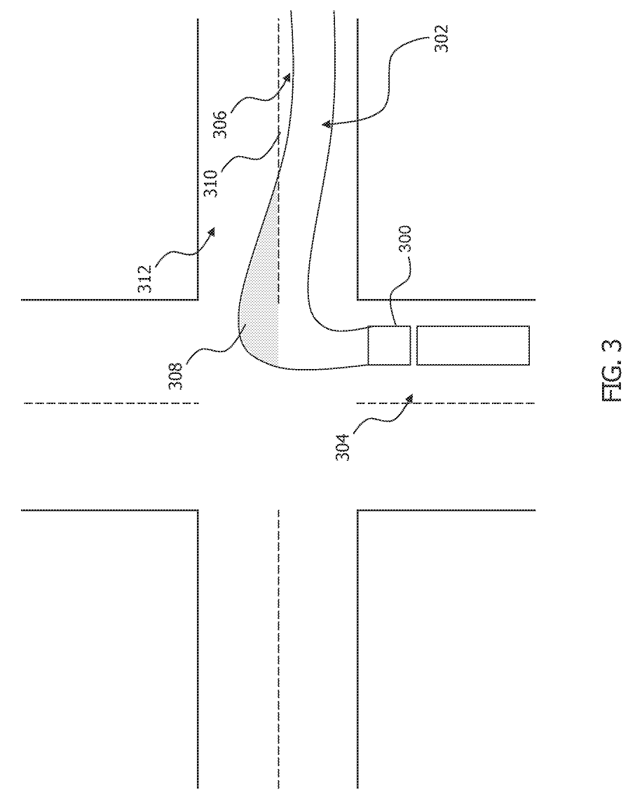

For example, and as described above, the vehicle 100 may be a truck that is conventionally connected to a single or tandem trailer to transport the trailer. When the truck is connected to the trailer, the truck commonly makes wide right-hand turns. FIG. 3 depicts an autonomous vehicle 300 performing an example maneuver 302 vehicle 100. Autonomous vehicle 300 may be similar to and perform similar functions as vehicle 100 shown in FIGS. 1-2. In this instance, autonomous vehicle 300 is executing the maneuver 302 to complete a right-hand turn from one lane 304 to another lane 306. A portion 308 of the maneuver 302 positions autonomous vehicle 300 over a centerline 310 and into an oncoming lane 312. This demonstrates a scenario where additional warning and signaling may be desired to alert other vehicles and drivers.

Autonomous vehicle 300 may include, for example, an autonomy computing system, such as autonomy computing system 200 shown in FIG. 2 and sensors, such as sensors 202 shown in FIG. 2, that precisely locate the autonomous vehicle 300 within the first lane 304 based upon the data received from the sensors 202. This allows autonomous vehicle 300 to keep the vehicle within the lane of operation, but, in instances as described above, the autonomous vehicle 300 also has advanced indication that the maneuver 302 will require the autonomous vehicle 300 to enter another lane of operation, such as the oncoming lane 312. Therefore, the autonomous vehicle 300 can generate and send signal data from the maneuver signaling module 242 to the signal system 110 (shown in FIG. 2) in advance of any maneuver that will take the autonomous vehicle 300, or a portion of the autonomous vehicle 300, outside of the desired lane of operation. Signal system 110 then emits an output signal based on the signal data. This advanced warning provides additional information to other vehicles and drivers in the vicinity of planned operations of the autonomous vehicle 300, leading to a safer environment.

Referring to signal system 110 shown in FIG. 2, in certain embodiments, the signal system 110 may cause the signal lights 112 to blink or flash in a blink pattern to indicate the upcoming maneuver. For example, the speed or cadence of the flashing can be modified based upon the situation or scenario. In one example, the flashes may start off slower and speed up as the vehicle is entering the portion 308 of the maneuver that is outside the lane of operation. Alternatively, the signal lights 112 may be constantly illuminated or maintained on throughout the maneuver 302. Different colors may also be employed by the signal lights 112. For example, different colors may be related to different scenarios or to a level of interruption that the vehicle, such as vehicle 100 shown in FIG. 1 or autonomous vehicle 300 shown in FIG. 3, may have on the surroundings. Referring to FIG. 3, in one example, the signal light 112 may start off as green, turn yellow as the vehicle 300 approaches the portion 308 where the vehicle 300 crosses the centerline 310, and turn red when the vehicle 300 is within the portion 308 of the maneuver where the vehicle 300 is outside of the lane of operation. In another example, the color of the light may be coded to a scenario. Wide right-hand turns may correspond with a red status of the signal lights 112, while a yellow status of the signal lights 112 may indicate the vehicle 300 is passing another vehicle in another lane of traffic. Any combination of maintained light, flashing light, and colored light may be used by the signal lights 112 to provide adequate warning to the surrounding vehicles and drivers.

Referring to FIGS. 1-2, in certain embodiments, audible signals may also be generated and used by the signal system 110. The audible signals may be constant or intermittent. As described with relation to the signal lights 112, the audible signals may be correlated to different scenarios or to different levels of interruption the maneuver may have on the surrounding vehicles or drivers. The audible signal may be a separately installed buzzer, horn, etc., or the audible signal may employ the conventional horn which is already installed on the vehicle 100. In some embodiments the audible and visual signals may be synchronized or coordinated. For example, the frequency of a blinking visual signal may match the frequency of an audible signal. In another example, a visual may initially be displayed in yellow with an audible signal, then the color may be changed to red and the audible signal may increase in volume in coordination with the change in color of the visual signal.

Referring to FIGS. 1-2, in certain embodiments, autonomy computing system 200 of vehicle 100 may perceive that another vehicle has a trajectory that will cause the other vehicle to enter into the lane of operation of vehicle 100. In such circumstances, autonomy computing system 200 and, more specifically, maneuver signaling module 242 may also send signal data to signal system 110 to similarly alert the other vehicle or driver to the perceived trajectory causing the other vehicle to enter into the lane of operation of vehicle 100.

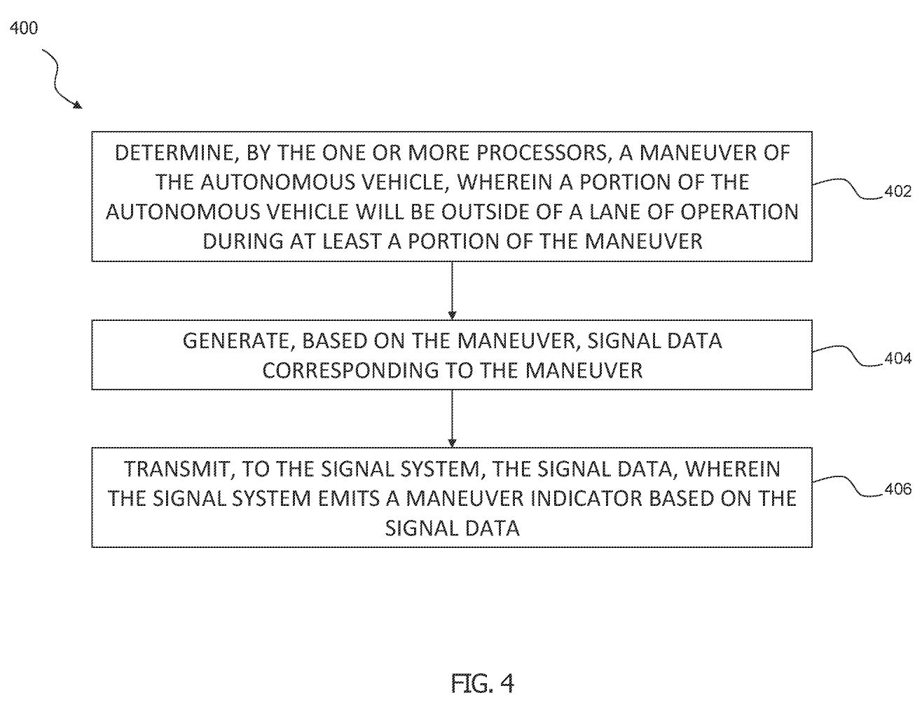

FIG. 4 is a flow diagram of an example method 400 of signaling on an autonomous vehicle. vehicle 100. Method 400 may be embodied, for example, in vehicle 100 shown in FIGS. 1-2 or autonomous vehicle 300 shown in FIG. 3. More specifically, method 400 may be embodied in software configured for execution by a computing system, such as maneuver signaling module 242 executing on autonomy computing system 200 shown in FIG. 2. The module determines 402, by one or more processors, a maneuver of the autonomous vehicle, wherein a portion of the autonomous vehicle will be outside of a lane of operation during the maneuver. As described above, one such maneuver could be a wide right-hand turn, but the maneuver may include any other movement of the vehicle, such as passing another vehicle, which may result in the autonomous vehicle operating outside of the lane of operation for a period of time. In some circumstances, only a portion of the vehicle will be outside of the lane of operation. In some circumstances, the vehicle may only be outside the lane of operation for a brief period of time. The determination that the vehicle, or a portion of the vehicle, will be outside the lane of operation may be made, for example, by autonomy computing system 200 or, more specifically, by behaviors and planning module 238 or maneuver signaling module 242. The module generates 404, based on the maneuver, signal data corresponding to the maneuver. The signal data can include data encoded specifying light patterns (blinking, flashing, maintained, etc.), light colors, or audible signals that may be emitted by a signal system, such as signal system 110 shown in FIGS. 1-2, of the vehicle 100 that will alert vehicles and drivers to the maneuver. The module transmits 406, to the signal system, the signal data. The signal system emits an output signal, which may be visual or audible, based on the signal data. In certain embodiments, autonomy computing system 200, or maneuver signaling module 242, further determines that the maneuver is complete and transmits a stop command to the signal system.

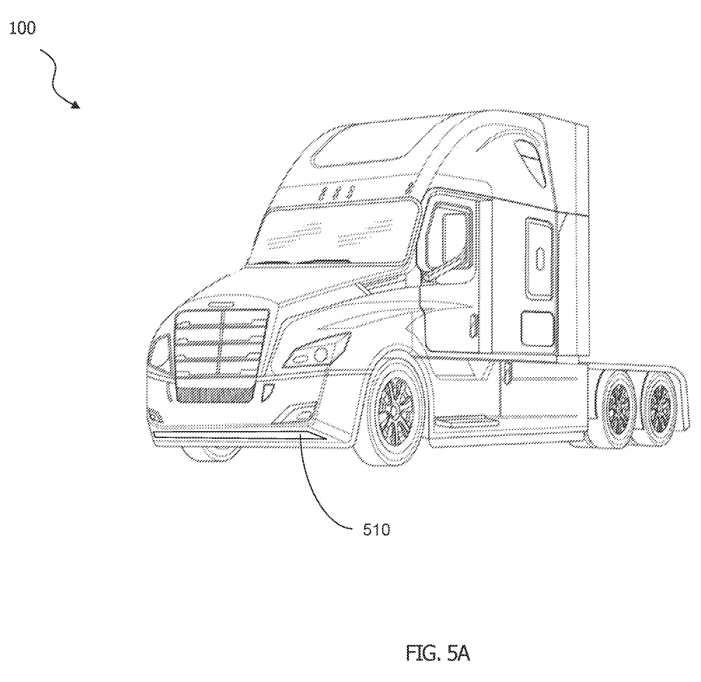

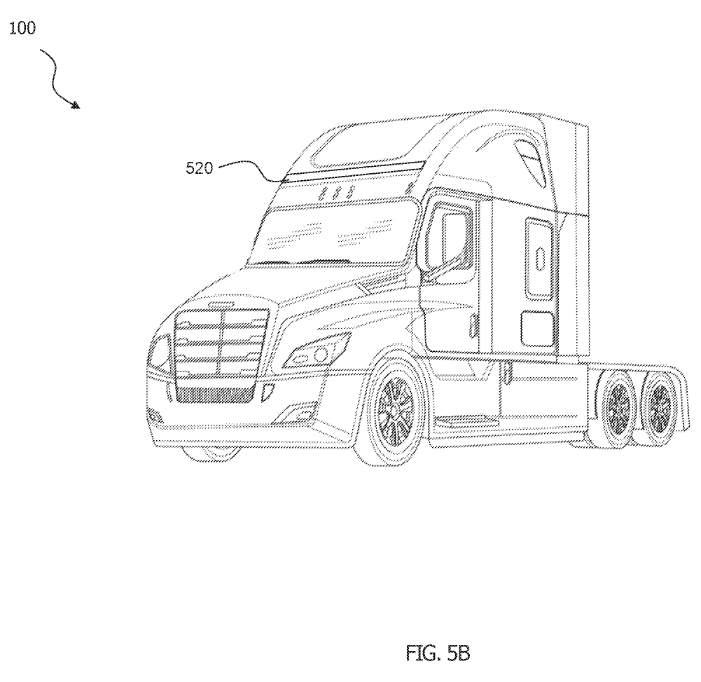

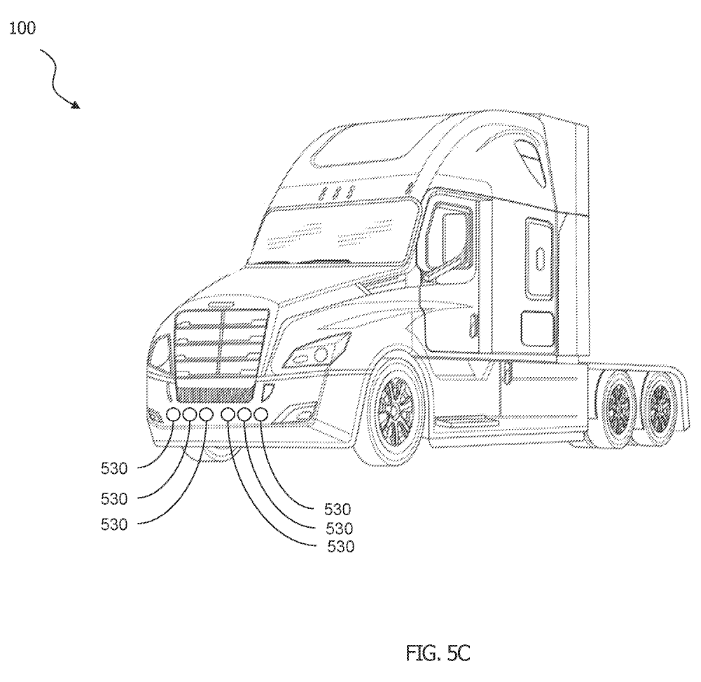

FIGS. 5A-5C illustrate various embodiments of the signal system 110 shown in FIGS. 1-2. These embodiments may be used interchangeably or in combination with any of the features of the signal system 110 and maneuver signaling module 242 described above. In certain embodiments, signal system 110 may include a light bar mounted, for example, horizontally. In alternative embodiments, the light bar may be mounted vertically or at any angle. In FIG. 5A, a lower light bar 510 is depicted. The lower light bar extends horizontally across the width of the vehicle 100. In FIG. 5B, an upper light bar 520 is depicted. Similarly, the upper light bar 520 extends horizontally across the width of the vehicle 100. Lower light bar 510 and upper light bar 520 may be illuminated, separately or in combination, in similar ways to communicate the maneuver of the vehicle 100. For example, the light may be blinking or cascading in a way as to indicate a direction of movement. Alternatively, a portion of the light bar corresponding to the portion of the vehicle 100 that will be outside the lane of operation could be illuminated to give surrounding vehicles and drivers an indication of how far the vehicle 100 plans to move into the other lane. For example, if 10% of the truck will operate within the other lane, 10% of the light bar may be illuminated. The light bars may also utilize a plurality of colors. These scenarios are provided as examples of ways the light bars could be used but are not intended to be limiting.

FIG. 5C depicts a plurality of signal lights 530. The signal lights 530 may be individual and may be used in any quantity, although six are depicted in FIG. 5C. The signal light 530 may be lit synchronously or in an alternating pattern. As described above, the signal lights 530 may utilize a plurality of colors.

Many possible variations exist for different types of lights or other signals that may be used in place of or in combination with those described above. For example, symbols (arrows, warning triangles, construction symbols) may be displayed via signal lights to communicate additional information. Similarly, numbers or text may be displayed. In these instances, display screens or the like may be employed to provide displays capable of displaying the desired symbols and/or text.

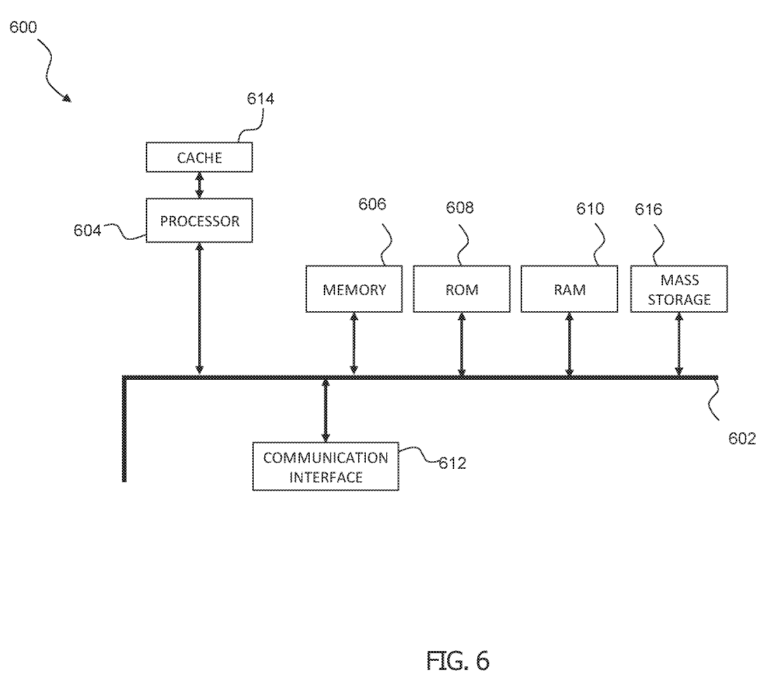

FIG. 6 illustrates an example computing system 600 that can implement various techniques, processes, functions, or methods described herein. The components of computing system 600 are shown in electrical communication with each other using a communication bus 602. The example computing system 600 includes a processor (CPU or processing unit) 604 coupled with communication bus 602 that couples various additional components to processor 604, including a memory 606, a read only memory (ROM) 608, and a random access memory (RAM) 610, and at least one communication interface 612. Communication interface 612 may include one or more additional components, such as integrated circuits, transceivers, transmitters, receivers, controllers, etc., for transmitting or receiving data over a channel. Such channels may include wired channels such as a serial channel, CAN bus, Ethernet or the like, or wireless channels employing protocols such as WiFi, Bluetooth, NFC, or other suitable wireless technologies.

In certain embodiments, as shown in FIG. 6, computing system 600 includes a cache 614 of high-speed memory connected directly with, in close proximity to, or integrated as part of processor 604. Computing system 600, in certain implementations, may copy data from memory 606 and/or a mass storage 616, also coupled with communication bus 602, to cache 614 for quick access by processor 604. In this way, cache 614 can improve performance of computing system 600 by reducing delays in processor 604 reading or writing data. These and other modules can store machine executable instructions for controlling, or configuring, processor 604 to perform various actions. Memory 606 can include multiple different types of memory with different performance characteristics. Processor 604 can include any general purpose processor, central processing unit (CPU), or graphics processing unit (GPU) in combination with a hardware or software provision configured to control processor 604. Such a software provision may be stored in memory 606, ROM 608, RAM 610, or mass storage 616. Processor 604 may, in certain embodiments, include a special-purpose processor where software instructions are incorporated into the processor design. Processor 604 may be a self-contained system, containing multiple cores or processors, a bus, memory controller, cache, etc. A multi-core processor may be symmetric or asymmetric.

Mass storage 616 is a non-volatile memory and can be one or more of a hard disk or other types of computer readable media that can store data that are accessible by a computer, such as a magnetic cassette, flash memory card, solid state memory device, digital versatile disk, cartridge, RAM, ROM, or hybrids thereof. Memory 606 or mass storage 616 can include machine executable instructions, software, code, firmware, etc., for controlling processor 604. In certain embodiments, processor 604 may be programmed, or configured, by encoding an operation or function using one or more machine executable instructions and providing the executable instructions in, for example, memory 606, ROM 608, RAM 610, or mass storage 616.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes providing enhanced ways of informing and warning other vehicles and drivers of actions of the autonomous vehicle which may be abnormal or may interfere with operations of other vehicles or drivers, thereby increasing safety.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more machine executable instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for ‎purposes of description, a wide variety of alternate and/or equivalent embodiments or ‎implementations calculated to achieve the same purposes may be substituted for the ‎embodiments shown and described without departing from the scope of the present disclosure. ‎This application is intended to cover any adaptations or variations of the embodiments ‎discussed herein, including the implementation or utilization of components of the systems or steps independently and separately from other described components or steps. Therefore, it is manifestly intended that embodiments described herein be ‎limited only by the claims.

What is claimed is:

1. A system of an autonomous vehicle, the system comprising:
a signal system located on an exterior of the autonomous vehicle;
one or more processors; and
a memory coupled to the one or more processors storing machine executable instructions that, when executed by the one or more processors, configure the system to:
determine, by the one or more processors, a maneuver of the autonomous vehicle, wherein a portion of the autonomous vehicle will be outside of a lane of operation during the maneuver;
generate, based on the maneuver, signal data corresponding to the maneuver; and
transmit, to the signal system, the signal data, wherein the signal system emits an output signal based on the signal data.

2. The system of claim 1, wherein the signal system includes a signal light, and wherein the signal system causes the signal light to emit the output signal.

3. The system of claim 2, wherein the signal data includes a blink pattern, wherein the blink pattern is emitted by the signal light of the signal system.

4. The system of claim 1, wherein the signal system includes at least one audible indicator.

5. The system of claim 1, wherein the signal system includes a horizontal light bar.

6. The system of claim 5, wherein the signal system illuminates a section of the horizontal light bar corresponding to the portion of the autonomous vehicle that will be outside of the lane the autonomous vehicle is operating within during the maneuver.

7. The system of claim 1, wherein the memory is further configured to store machine executable instructions that, when executed by the one or more processors, configure the system to:
determine when the maneuver is complete; and
transmit a stop command to the signal system.

8. A method of signaling on an autonomous vehicle, the method comprising:
determining, by one or more processors of the autonomous vehicle, a maneuver of the autonomous vehicle, wherein a portion of the autonomous vehicle will be outside of a lane of operation during the maneuver;
generating, by the one or more processor of the autonomous vehicle and based on the maneuver, signal data corresponding to the maneuver; and
transmitting, to a signal system of the autonomous vehicle, the signal data, wherein the signal system emits an output signal based on the signal data.

9. The method of claim 8, wherein the signal system includes a signal light, and wherein the signal system causes the signal light to emit the output signal.

10. The method of claim 9, wherein the signal data includes a blink pattern.

11. The method of claim 8, wherein the signal system includes at least one audible indicator.

12. The method of claim 8, wherein the signal system includes a horizontal light bar.

13. The method of claim 12, wherein the signal system illuminates a section of the horizontal light bar corresponding to the portion of the autonomous vehicle which will be outside of the lane the autonomous vehicle is operating within during the maneuver.

14. The method of claim 8 further comprising:
determining when the maneuver is complete; and
transmitting a stop command to the signal system.

15. A non-transitory computer-readable storage medium, the non-transitory computer-readable storage medium including instructions that when executed by a computer, configure the computer to:
determine a maneuver of an autonomous vehicle, wherein a portion of the autonomous vehicle will be outside of a lane of operation during the maneuver;
generate, based on the maneuver, signal data corresponding to the maneuver; and
transmit, to a signal system of the autonomous vehicle, the signal data, wherein the signal system emits an output signal based on the signal data.

16. The non-transitory computer-readable storage medium of claim 15, wherein the signal system includes a signal light, and wherein the signal system cause the signal light to emit the output signal.

17. The non-transitory computer-readable storage medium of claim 16, wherein the signal data includes a blink pattern.

18. The non-transitory computer-readable storage medium of claim 15, wherein the signal system includes at least one audible indicator.

19. The non-transitory computer-readable storage medium of claim 15, wherein the signal system includes a horizontal light bar.

20. The non-transitory computer-readable storage medium of claim 19, wherein the signal system illuminates a section of the horizontal light bar corresponding to the portion of the autonomous vehicle which will be outside of the lane the autonomous vehicle is operating within during the maneuver.
